(19) United States
(12) Patent Application Publication
(10) Pub. No.: US 2006/0234089 A1
(43) Pub. Date: Oct. 19, 2006

(54) Multi-layered sputtered thin metal film recording medium comprising a tungsten seed layer and a chromium-titanium-tungsten intermediate layer

(75) Inventor: Michael B. Hintz, Mahtomedi, MN (US)

Correspondence Address: Attention: Eric D. Levinson;Imation Corp., Legal Affairs, P.O. Box 64898, St. Paul, MN, 55164-0898, US

(73) Assignee: Imation Corp.

(21) Appl. No.: 11/105,815

(22) Filed: Apr. 13, 2005

(51) Int. Cl. G11B 5/66

(52) U.S. Cl. 428/831

(57) ABSTRACT

A multi-layered sputtered thin metal film recording medium comprising a flexible substrate, a tungsten seed layer having a thickness of less than about 10 nm, an intermediate layer formed from a chromium-titanium-tungsten alloy, and a recording layer formed from a cobalt alloy. In one embodiment, the recording layer exhibits an in-plane coercivity of at least about 2800 Oe and all layers are deposited at ambient temperature.

### THE FIELD OF THE INVENTION

The present invention relates generally to a flexible sputtered thin film magnetic recording media, specifically a multi-layered sputtered thin metal film recording medium comprising a tungsten seed layer having a thickness of less than about 7 nm.

### BACKGROUND OF THE INVENTION

Modem hard disc drives incorporate sputtered metal film recording media almost exclusively as such sputtered metal films have the highest performance of any type of magnetic recording media. Other types of recording media may also employ such thin film magnetic layers. Sputtered metal magnetic media use thin metal layers to record digital data. Such thin metal layers typically employ a cobalt alloy.

In media based on a thin metallic magnetic recording layer, such as a magnetic cobalt alloy, the overall media construction typically will be multilayered. The thin film magnetic recording media of the invention comprise several thin films coated in sequence upon a substrate which form a “thin film stack.” The first layers coated generally function to provide a combination of adhesion, topographical texture, and crystalline texture. These layers are then followed by one or more magnetic thin films which do the actual information storage. The magnetic thin films are followed by one or more coatings which provide environmental stability, hardness, and compatibility with the subsequently coated lubricant. A lubricant layer constitutes the final layer of the thin film media.

The medium substrate for hard disc drives (HDD) is typically an aluminum alloy or chemically hardened glass. HDD substrates are typically at least 0.5 mm thick. Such substrates can withstand processing temperatures of 250 C or greater during thin film deposition. Recently interest has developed in using sputtered metal films for flexible media applications such as data tape to increase the storage density of the media. The substrate for a flexible recording medium is a non- magnetic substrate, typically formed from a flexible polymeric material less than 25 micrometers (0.025 mm) thick. Conventionally used substrate materials include polyesters such as polyethylene terephthalate (PET), polyethylene naphthalate (PEN), and mixtures thereof; polyolefins (e.g., polypropylene); cellulose derivatives; polyamides; and polyimides.

Sputtered metal films are subject to the development of stresses which can cause the undesirable curling of the substrate either toward away from the sputtered film side. Such curling degrades the recording abilities of the medium and may even result in cracking of the substrate or the thin films.

The layers of sputtered thin film hard disc media have typically been deposited onto the substrate at elevated temperatures, such as 200-300° C., in order to promote the growth of a preferred crystal structure, i.e., most preferably a structure with growth of the chromium (112) planes in an axis parallel to the film (substrate) plane. Such a structure yields a recording media with the (10.0) preferred orientation of the Co alloy planes parallel to the film plane and provides optimal recording properties. Unfortunately, recording layers deposited at ambient temperatures typically do not promote growth of the (10.0) preferred Co alloy orientation, resulting in less desirable recording properties. The need for use of elevated temperatures during the deposition limits the type of polymeric substrates which can be used for flexible thin film magnetic recording media production.

The deposition at elevated temperatures also segregates non-magnetic materials contained in the cobalt alloy to the boundaries of the magnetic grains, and reduces intergranular exchange coupling at the grain boundaries. This segregation is highly desirable, and results in reduced media transition noise.

It has now been discovered that the use of a thin tungsten seed layer upon which the other layers are “grown” and a chromium titanium alloy intermediate layer will provide a thin film recording medium wherein the Co-alloy recording layer has increased desirable Co (10.1) texture.

It has also been discovered that the addition of tungsten to a chromium-titanium intermediate layer deposited over the seed layer can significantly reduce the amount of residual stress in the composite thin film stack without degrading the resultant medium's magnetic properties.

It has also been discovered that growing a recording layer atop a thin tungsten seed layer and a chromium-titanium-tungsten alloy intermediate layer produces a recording media stack which exhibits the desired (10.1) orientation of the recording layer for longitudinal magnetic recording without the required use of elevated temperatures during the deposition.

A multi-layered sputtered thin metal film recording medium may now be formed comprising a flexible substrate, a tungsten seed layer having a thickness of less than about 10 nm, an intermediate layer formed from a chromium-titanium- tungsten alloy, and a recording layer formed from a cobalt alloy, wherein said recording layer exhibits an in-plane coercivity of at least about 2800 Oersteds, exhibits minimized stress in the film stack, and minimal cupping/curling of the substrate. Such a medium may be produced at ambient deposition temperatures.

### SUMMARY OF THE INVENTION

The invention provides a multi-layered sputtered thin metal film recording medium (also called a “magnetic recording stack” in the industry) comprising a flexible polymeric substrate and a tungsten seed layer coated thereon having a thickness of less than about 10 nm, an intermediate layer formed from a chromium-titanium-tungsten alloy, and a cobalt alloy recording layer formed thereon.

Specifically, the invention provides a sputtered thin metal film recording medium comprising a flexible polymeric substrate having multiple layers deposited thereon; a tungsten seed layer having a thickness of less than about 10 nm, an intermediate layer formed from a alloy containing chromium, tungsten and an element selected from titanium, vanadium, manganese and tantalum, and a recording layer formed from a cobalt alloy.

The invention further provides a sputtered thin metal film recording medium comprising a flexible polymeric substrate having multiple layers deposited thereon; a tungsten seed layer having a thickness of less than about 10 nm, an intermediate layer formed from a alloy containing chromium, tungsten and an element selected from titanium, vanadium, manganese and tantalum, and a recording layer formed from a cobalt alloy wherein such recording layer exhibits an in-plane coercivity of at least about 2800 Oersteds.

In one embodiment, the invention provides a thin film magnetic recording medium having longitudinal tracks comprising a substrate having deposited thereon, a tungsten seed layer having a thickness of less than about 8 nm, an intermediate layer formed from an alloy containing chromium, tungsten and titanium, and a recording layer formed from a cobalt alloy, wherein the recording layer exhibits an in-plane coercivity of at least about 2800 Oersteds.

In another embodiment, the invention provides a multi-layered thin-film longitudinal recording medium where the tungsten seed layer thickness is from about 2 nm to 8 nm.

In yet another embodiment, the invention provides a multi-layered sputtered thin film recording medium wherein the chromium-based intermediate layer has a crystal structure with significantly increased growth of (112) planes parallel to the film plane when compared to an intermediate layer of a similar thin film recording medium not having a tungsten seed layer.

These terms when used herein have the following meanings.

1. The term “coating composition” means a composition suitable for coating onto a substrate.

2. The terms “layer” and “coating” are used interchangeably to refer to a coated composition.

3. The term “coercivity” means the intensity of the magnetic field needed to reduce the magnetization of a ferromagnetic material to zero after it has reached saturation, taken at a saturation field strength of 10,000 Oersteds.

4. The term “Oersted,” abbreviated as Oe, refers to a unit of magnetic field strength in the cgs unit system.

5. The terms “layer” or “coating” are used interchangeably to refer to a coated composition, which may be the result of one or more deposition processes and one or more passages through the coating apparatus.

6. The term “lubricant” means a substance introduced between two adjacent solid surfaces, at least one of which is capable of motion, to produce an antifriction effect between the surfaces.

7. The term “protective layer” means a substance applied to the magnetic layer for purposes of protecting it mechanically or chemically, and not primarily as a lubricant.

8. The term “direction of easy magnetization” means the magnetization direction in the crystal for which the stored crystalline anisotropy energy is minimized.

9. The terms “perpendicular remenance” and “parallel remenance” refer to the magnetization remaining in the thin film magnetic material after saturating the material and then reducing the applied magnetic field to zero in directions perpendicular or parallel to the thin film plane, respectively.

10. The terms “<abc>” and “<ab.c>” where a, b, and c are whole numbers specify crystallographic directions in cubic and hexagonal close-packed structures, while the terms “(abc)” and “(ab.c)” are the Miller indices of crystallographic planes in cubic and hexagonal structures respectively. Detailed descriptions of concepts including crystallographic directions and Miller indices can be found in a variety of references on X-ray diffraction and crystallography (2).

11. The term “texture”, when referring to a thin film indicates that the orientation of the crystallites (grains) forming the thin film is not random, but that specific film planes, typically specified by Miller indices, are preferentially arranged parallel to the film plane. For example, stating that a thin film exhibits a (110) texture means that the film comprises a number of crystallites with (110) crystal planes oriented parallel to the film surface.

12. The term “visible curl” means curling of the thin film medium which is visible to the unaided eye. A medium with no visible curl will appear to lay flat.

### BRIEF DESCRIPTION OF THE DRAWINGS

FIG. 1. is a graph of X-ray diffraction data showing Intensity in Counts plotted against Two-Theta for a thin film magnetic recording medium containing no tungsten seed layer.

FIG. 2 is a graph of X-ray diffraction data showing Intensity in Counts plotted against Two-Theta for a thin film magnetic recording medium containing a thin tungsten seed layer.

FIG. 3 is a graph of inverse substrate curvature versus tungsten deposition power used to form a CrTiW intermediate layer.

### DETAILED DESCRIPTION OF THE PREFERRED EMBODIMENTS

The following detailed description describes certain embodiments and is not to be taken in a limiting sense. The scope of the present invention is defined by the appended claims.

The thin film magnetic recording medium includes a substrate, a tungsten seed layer, an intermediate layer containing tungsten and a magnetic recording layer and, optionally, one or more protective layers and one or more lubricant layers. The various components are described in greater detail below. In general terms, however, the tungsten seed layer is less than 10 nm in thickness and the intermediate layer contains chromium and tungsten.

In one embodiment, the magnetic recording medium may be a flexible recording medium such as a magnetic data storage tape.

Magnetic Recording Layer(s)

The thin film magnetic recording medium of the invention will include at least one magnetic recording layer formed from a metal or metal alloy such as cobalt, cobalt chrome, cobalt nickel, cobalt chrome platinum, and other cobalt alloys formed on the substrate by sputtering. The recording layer has a hexagonal close-packed (hcp) crystal structure.

The crystallographic alignment of the thin film recording layer determines, to a large extent, the magnetic recording characteristics and quality. The crystallites (grains) of the Co-alloy recording layer have one axis of magnetization known as the easy axis of magnetization which corresponds to the <00.1> crystallographic direction in the hexagonal close packed structure. In devices that utilize longitudinal recording such as current hard disc drives and other direct access storage devices, the easy axis of magnetization is most preferably parallel to the film substrate.

Seed Layer

The seed layer in the magnetic recording media of the invention is a tungsten (W) seed layer, having a thickness of no greater than about 10 nm. In one embodiment, the seed layer has a thickness of from about 2 nm (nanometers) to about 10 nm, preferably from about 2 nm to about 8 nm, most preferably from about 4 nm to 6 nm. Use of this thin tungsten seed layer significantly alters the texture of a subsequently deposited chromium based alloy intermediate layer.

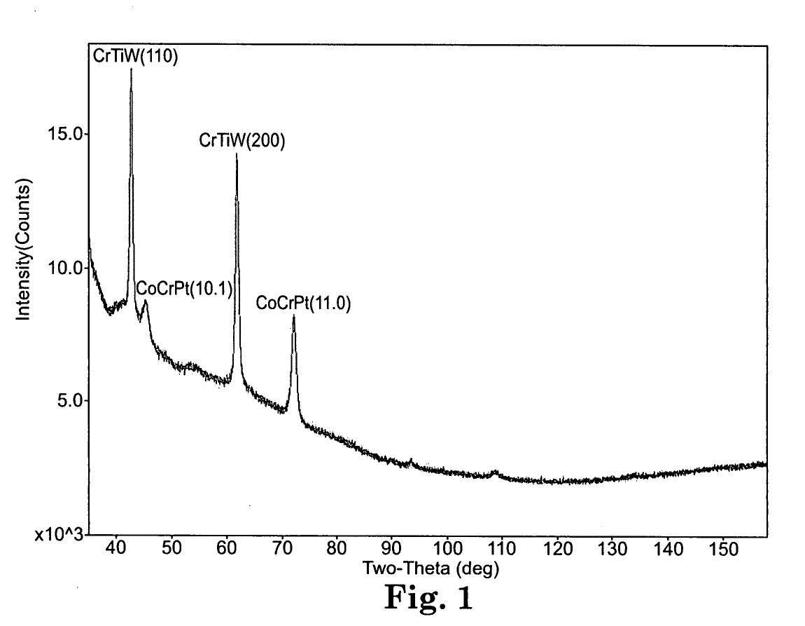

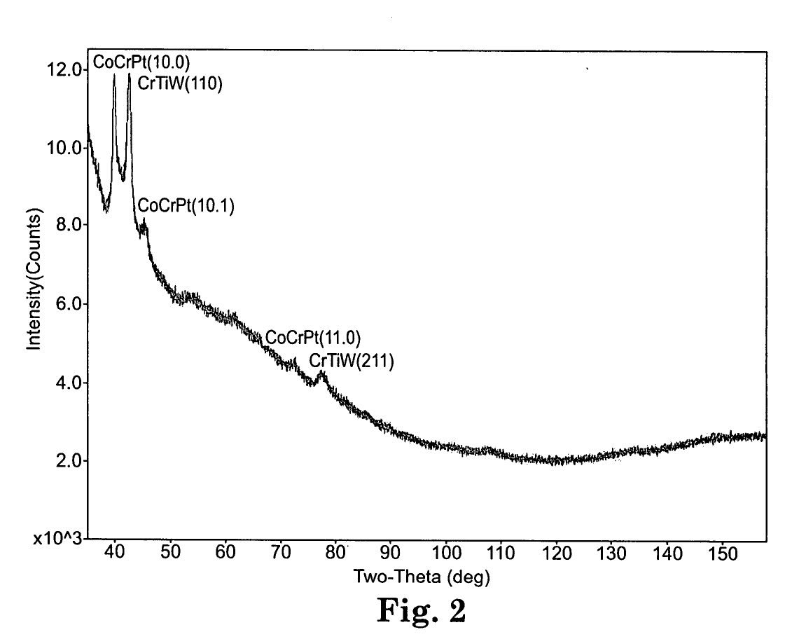

Specifically, as can be seen by reference to FIGS. 1 and 2, the inclusion of the tungsten seed layer reduces the chromium (110) and (200) textures and increases the most desirable chromium (112) texture. The change in chromium texture beneficially alters the subsequently deposited cobalt chromium platinum (CoCrPt) alloy texture. Specifically, the CoCrPt (11.0) and (10.1) textures are reduced, and the most desirable CoCrPt (10.1) texture is increased. The seed layer is sputtered onto the substrate from an elemental tungsten target.

Intermediate Layer

The intermediate layer of magnetic recording media of the invention includes an alloy of chromium, tungsten, and a third element selected from titanium, vanadium, manganese and tantalum. In one embodiment of the invention, the chromium-based alloy contains from about 5 to about 20% tungsten and from about 5 to about 10 % of the third element. In one embodiment, the third element in the intermediate layer is titanium.

A chromium-based underlayer deposited at room temperature directly on a substrate typically promotes growth of the chromium (110) texture which promotes growth of a (10.1) texture in the subsequently-coated magnetic recording layer. Consequently, the easy axis of magnetization is tilted out of the film plane by about 30 degrees, resulting in less desirable recording characteristics However, when the tungsten containing chromium alloy intermediate layer is grown atop the thin tungsten seed layer, and the recording layer is grown atop this intermediate layer, the growth of crystals with (10.1) texture is substantially reduced, and the amount of crystals having (10.0) planes parallel to the film plane is significantly increased, even when the recording layer is deposited at room temperature. Further, the use of the tungsten-containing chromium alloy intermediate layer significantly reduces the film stack's tensile stress without degrading the finished medium's magnetic properties.

Magnetic recording media of the invention have improved magnetic properties and significantly reduced tendencies for the flexible substrate to curl.

Magnetic recording media according to the invention have in-plane (parallel to the film plane) coercivities of at least about 2500 Oe, preferably at least about 2650 Oe, and in one embodiment, as much as 2800 Oe.

Substrate

The substrate which is to be coated with the magnetic recording layer may be any non-magnetic substrate, but is preferably a flexible polymeric substrate having a thickness of from about 4 micrometers to about 60 micrometers. Useful substrates include polyolefins such as polyethylene terephthalate, polyethylene naphthalate, polypropylene and the like, as well as polyamides and polyimides.

Method of Manufacture

After deposition of the magnetic layer(s), an optional protective coating of, for example (but not limited to), diamond-like carbon may be deposited by a suitable method. This may be done for protection against corrosion or for increased durability, or both. The magnetic recording medium formed according to the invention is capable of decreasing the need for such a protective coating. If desired, useful protective layers may include such materials as diamond-like carbon layers, SiC layers, amorphous carbon, nitrogenated or hydrogenated amorphous carbon, or silicon nitride.

When all the layers have been coated, finishing processes such as polishing or burnishing may be performed. A lubricant layer may then be applied by conventional methods. For example, the lubricant compound may be dissolved in a solvent, and the thin film medium dipped in the lubricant solution for a sufficient time to allow the solution to contact the surface, and then drained, or the lubricant solution may be pumped over the recording medium and then allowed to drain. The lubricant may be any conventional lubricant known in the industry, e.g., a fluorinated hydrocarbon, or, more specifically, a fluorinated polyether.

### EXAMPLES

### Deposition

Nominally 4″×6″ “coupon” sputtered metal film (“SMF”) media samples were prepared on 20 μm thick UBE polyimide substrates. Other substrates, such as 4.5 μm thick Toray QX52 Aramide, yield similar results. A series of samples were prepared with varying W seed layer thicknesses. The stack construction was X nm W/44 nm CrTi9W19/25 nm CoCr18Pt22. Table 1 lists some of the relevant magnetic properties as a function of W seed layer thickness, X.

Sputtered film deposition was performed in the Imation Magnetic Coupon Coater (MCC), a multi-target sputtering machine which can co-sputter materials from up to 9 target materials. Base pressure of the system prior to deposition was <10⁻⁷ Torr. Deposition of all layers was done at an argon working gas pressure of 10 mTorr. The tungsten (W) seed layers were deposited from an elemental W Target. The CrTiW intermediate layers were deposited by co-sputtering fro Cr, W, Ti, and/or TiW₅₀ targets. Magnetic layers were deposited either from an alloy CoCr₁₈Pt₂₂ target or co-sputtered from a CoCr₁₀ and elemental Pt target; the composition of the co-sputtered magnetic layer was CoCr₈Pt₂₃. All composition values refer to atomic percent.

SiO2 was added to the magnetic layer on several samples to reduce intergranular exchange coupling. Deposition of all metallic layers was accomplished using DC magnetron sputtering. For samples employing SiO₂- doped CoCrPt magnetic layers, an amorphous SiO₂ target was co-sputtered with the magnetic materials using a RF magnetron.

Magnetic characterization of the samples was accomplished using an Alternating Gradient Magnetometer (AGM) (Princeton Measurements Corporation Micromag® 2900). Structural characterization of the samples was performed using a theta-2theta X-ray diffractometer and Cu Kα radiation (Rigaku® RINT 2000).

TABLE 1

| | | Hc par | | |
|---|---|---|---|---|
| Run ID | Seed thk.(nm) | (KOe) | Hc perp/Hc par | Mr/Ms perp. |
| 031004-1 | 0 | 2.651 | 0.632 | 0.245 |
| 031104-2 | 2.5 | 2.508 | 0.626 | 0.252 |
| 030904-1 | 5 | 2.856 | 0.443 | 0.201 |
| 031104-1 | 10 | 2.604 | 0.605 | 0.240 |

The sample with a tungsten seed layer thickness of 5 nm exhibits increased in-plane coercivity, a significant reduction in the ratio of perpendicular to parallel coercivity, and decreased perpendicular remenance; all of these characteristics are desirable for longitudinal recording applications. Comparison of X-ray diffraction data from samples 031004-1 (0 nm W, FIG. 1) and 030904-1 (5 nm W, FIG. 2) reveals significant microstructural differences.

As shown in FIG. 2, addition of the 5 nm W seed layer greatly reduced the amount of (110) and (200) and increases the amount of (112) texture in the CrTiW intermediate layer. The net result is that the (11.0) and (10.1) texture in the CoCrPT are reduced, while the most desirable (10.0) CoCrPt texture is greatly increased. The XRD data are therefore consistent with the magnetic data.

Sputtered metal media deposited at room temperature generally exhibit little grain boundary segregation and are consequently tightly exchange coupled; this is undesirable for recording applications, as it greatly increases media transition noise. The thin tungsten seed layer was effective at improving orientation in CoCrPt layers doped with SiO2. Samples incorporating up to about 30 volume % SiO2 in the magnetic layers exhibited similar responses to the presence or absence of the 5 nm W seed layer. In fact, the W seed layer effects an even more dramatic improvement in magnetic properties for media comprising SiO2-doped magnetic layers.

Conventional film stacks made employing CrTi10 underlayers exhibit tensile stresses, i.e., a free standing piece of the coated media curled fairly strongly toward the sputtered film side of the substrate. It was discovered that the addition of tungsten to the intermediate layer reduced the tensile stress in the resulting media. In fact, the addition of sufficient W to the intermediate layer changes the film stress from tensile to compressive. Remarkably, as much as 20% or more tungsten can be added to the intermediate layer without adversely affecting the magnetic properties of the resulting medium.

As illustration of the behavior described above, a series of roughly 6″×4″ coupon samples with varying W concentrations were prepared on sheets of 20 μm UBE polyimide. The nominal structure of the samples was 5 nm W/50 nm Cr₉₀Ti₁₀/23 nm CoCrPt-SiO2. W was added to the Cr₉₀Ti₁₀ intermediate layer by co-sputtering to produce samples described in Table 2.

TABLE 2

| | Tungsten | | | |
|---|---|---|---|---|
| | Deposition | | | |
| Run ID | power (W) | Hc par (KOe) | Hc perp/Hc par | Mr/Ms perp. |
| 012805-1 | 220 | 2.841 | 0.386 | 0.151 |
| 020105-1 | 165 | 3.019 | 0.404 | 0.142 |
| 020205-1 | 110 | 2.992 | 0.407 | 0.150 |
| 020405-1 | 55 | 3.271 | 0.398 | 0.136 |
| 020705-1 | 0 | 3.011 | 0.546 | 0.200 |

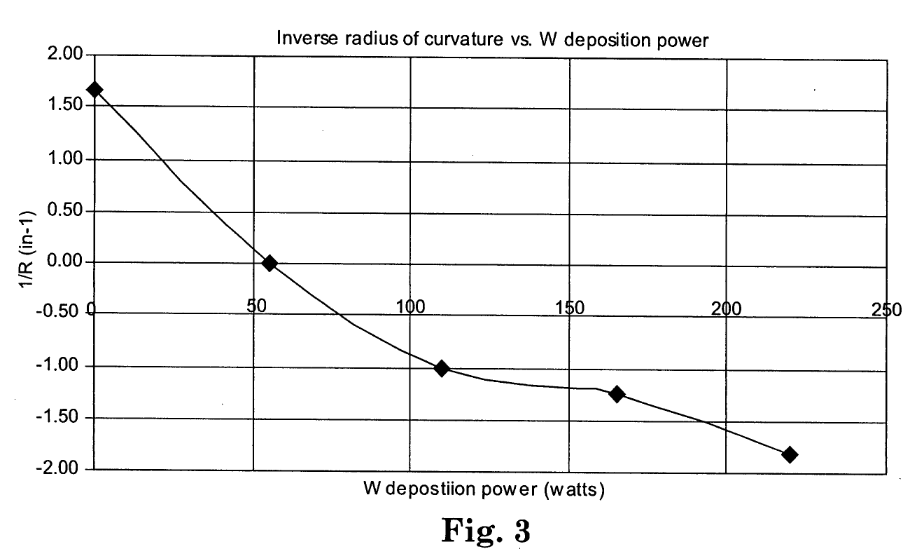

A 0.5″ by 4″ segment was cut from each coupon, supported on edge at one end on a smooth surface, and allowed to assume its stable freestanding radius. The radius of curvature, R, was then measured for each sample. As used here, a positive radius of curvature indicates that the sample curved toward the deposited film stack (tensile stress), while a negative radius of curvature indicates that the sample curved away from the deposited film stack (compressive stress). To a first approximation, 1/R is proportional to the thin film stress. FIG. 3 is a graph plotting 1/R versus the tungsten deposition power used to prepare the co-sputtered CrTiW intermediate layer. A tungsten deposition power of 220 W corresponds to a tungsten content in the film of about 19%. The tungsten content of the intermediate layer decreases monotonically with decreasing deposition power. As shown in FIG. 3, the film stress changes from tensile to increasingly compressive as tungsten is added to the intermediate layer; however, examination of Table 2 reveals that the magnetic properties of the film are only weakly affected by tungsten composition over a composition range of from 0% to about 20% tungsten. Consequently, the stress of the film stack can be tuned for specific applications by varying tungsten composition. For example, a complete media construction requires a 2-10 nm thick overcoat such as amorphous carbon or silicon nitride to improve tribological characteristics. Amorphous carbon overcoat layers typically exhibit high compressive stress which can lead to undesirable curling of flexible media. By reducing the tungsten composition in the CrTiW intermediate layer, the compressive stress in the carbon overcoat can be compensated for by a slightly tensile stress in the remainder of the film stack, thereby resulting in a flexible recording medium with reduced tendencies for curling or other undesirable deformation.

What is claimed is:

1. A multi-layered sputtered thin metal film flexible recording medium comprising a flexible polymeric substrate having formed on at least one surface thereof a tungsten seed layer having a thickness of less than about 10 nm, an intermediate layer formed from an alloy containing chromium, tungsten and an element selected from the group consisting of titanium, vanadium, manganese and tantalum, and a recording layer formed from a cobalt alloy.

2. A multi-layered thin metal film flexible recording medium according to claim 1, wherein said recording layer exhibits an in-plane coercivity of at least about 2800 Oersteds.

3. A multi-layered sputtered thin film flexible recording medium according to claim 1, wherein said layers are deposited on said substrate at ambient temperature.

4. A multi-layered thin-film longitudinal flexible recording medium according to claim 1, wherein the tungsten seed layer thickness is no greater than 8 nm.

5. A multi-layered thin-film longitudinal flexible recording medium according to claim 1, wherein the tungsten seed layer thickness is from about 2 nm to 8 nm.

6. A multi-layered thin-film longitudinal flexible recording medium according to claim 14, wherein the tungsten seed layer thickness is from about 4 nm to 6 nm.

7. A multi-layered thin-film longitudinal flexible recording medium according to claim 1, wherein the intermediate layer is a chromium-based alloy comprising from about 3 to about 20% tungsten and from about 1 to about 10 % of an element selected from the group consisting of titanium, vanadium, manganese and tantalum.

8. A multi-layered sputtered thin film flexible recording medium according to claim 7, wherein said intermediate layer comprises an alloy containing titanium.

9. A multi-layered sputtered thin film flexible recording medium according to claim 1 having a ratio of perpendicular coercivity to parallel coercivity of less than about 0.5.

10. A multi-layered sputtered thin film flexible recording medium according to claim 1 having a ratio of perpendicular remenance to parallel remenance of less than about 0.240.

11. A multi-layered sputtered thin film flexible recording medium according to claim 7, wherein said layers are deposited on said substrate at ambient temperature.

12. A multi-layered sputtered thin film flexible recording medium according to claim 1, wherein the tungsten concentration in the intermediate layer comprises from about 3% to about 20% wherein said medium exhibits no visible curl.

13. A multi-layered sputtered thin film flexible recording medium according to claim 1, wherein said polymeric substrate is selected from the group consisting of polyimides, polyethylene terephthalate (PET), polyethylene naphthalate (PEN), and mixtures thereof; polypropylene; cellulose derivatives, and polyamides.

14. A tape data storage system comprising a multilayered sputter-deposited thin metal film recording medium including a flexible polymeric substrate having deposited on at least one surface thereon at least a recording layer formed from a cobalt alloy, said layer having been grown atop an intermediate layer formed from a chromium-titanium-tungsten alloy, and a tungsten seed layer having a thickness of less than about 10 nm, said medium having an in-plane coercivity of at least about 2800 Oe.

15. A tape data storage system according to claim 14, wherein said layers are deposited on said substrate at ambient temperature.

16. A tape data storage system according to claim 14, wherein the tungsten seed layer thickness is no greater than 8 nm.

17. A tape data storage system according to claim 14, wherein the tungsten seed layer thickness is from about 2 nm to 8 nm.

18. A tape data storage system according to claim 14, wherein the tungsten seed layer thickness is from about 4 nm to 6 nm.

19. A tape data storage system according to claim 14, wherein the intermediate layer is a chromium-based alloy comprising from about 3 to about 20% tungsten and from about 1 to about 10 % of an element selected from the group consisting of titanium, vanadium, manganese and tantalum.

20. A tape data storage system according to claim 19, wherein said intermediate layer comprises an alloy containing titanium.

21. A tape data storage system according to claim 14, wherein said recording layer is formed from a cobalt-chromium-platinum alloy.
